(19) United States
(12) Patent Application Publication
(10) Pub. No.: US 2007/0236433 A1
(43) Pub. Date: Oct. 11, 2007

(54) Control method and control apparatus for liquid crystal display

(75) Inventor: Fumio Koyama, Shiojiri-shi (JP)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 11/727,517

(22) Filed: Mar. 27, 2007

(30) Foreign Application Priority Data
Apr. 5, 2006 (JP) 2006-103852

(51) Int. Cl. G09G 3/36

(52) U.S. Cl. 345/87

(57) ABSTRACT

The image display apparatus of the invention applies a tone-based voltage, which corresponds to a tone value of image data at each of multiple pixels on a VA liquid crystal display, to the pixel for display of an image represented by the image data on the VA liquid crystal display. The tone-based voltage of each pixel is restricted, based on a transmittance-voltage characteristic of the pixel that differs by the position of the pixel on the plane of the VA liquid crystal display. This arrangement ensures application of adequate voltages according to the tone values of image data to the VA liquid crystal, thus enhancing the quality of images displayed on the VA liquid crystal display.

### CROSS REFERENCE

The present application claims the priority based on Japanese Patent Application No. 2006-103852 filed on Apr. 5, 2006, the disclosure of which is hereby incorporated by reference in its entirety.

### BACKGROUND

1. Field of the Invention

The present invention relates to control of a liquid crystal display. More specifically the invention pertains to control of a liquid crystal display including liquid crystal molecules that are sealed between opposed base plates and are aligned in a vertical direction relative to the base plates in a non-voltage application'state to block the transmission of light while changing their alignment toward a horizontal direction relative to the base plates with an increase in applied voltage to allow the transmission of light.

2. Description of the Related Art

There are different types of liquid crystals classified by the characteristics of the liquid crystal alignment. The liquid crystal having the above characteristic of the liquid crystal alignment is generally called VA (Vertical Alignment) liquid crystal. The VA liquid crystal has the short response time and the relatively wide view angle, because of the occurrence of no twist in the changed alignment of liquid crystal with an increase in applied voltage. Such advantages of the VA liquid crystal lead to the rapid spread of VA liquid crystal displays.

The image display on the VA liquid crystal applies the voltage corresponding to the tone value of image data at each pixel of the liquid crystal and accordingly varies the transmittance of the liquid crystal at each pixel. Diverse techniques have been proposed for control of this applied voltage (see, for example, JP-A-2005-91454). The technique disclosed in this cited patent reference controls the applied voltage with a variation in tone value for the enhanced response.

The transmittance of the VA liquid crystal increases with an increase in applied voltage in a range between a minimum transmittance (lower peak value) and a maximum transmittance (upper peak value). As is generally known in the art, however, the transmittance of the VA liquid crystal is lowered with an increase in applied voltage in a voltage range over an upper limit voltage corresponding to the maximum transmittance and in a voltage range below a lower limit voltage corresponding to the minimum transmittance. Application of the voltage corresponding to the tone value of the image data by neglecting such transmittance-voltage characteristic may cause application of the voltage over the upper limit voltage or application of the voltage below the lower limit voltage. This leads to an undesirable variation in luminance on the screen plane of the liquid crystal display. The prior art technique adopted for the VA liquid crystal having such transmittance-voltage characteristic uniformly imposes a limitation on the applied voltage and allows application of the voltage only in a restricted range of ensuring an increase in transmittance with an increase in applied voltage.

The uniform limitation on the applied voltage prevents application of the voltage over the upper limit voltage and application of the voltage below the lower limit voltage. Although this uniform limitation aims to prevent the variation in luminance over the whole screen plane of the liquid crystal display, the resulting effect does not homogeneously improve the luminance variation over the whole screen plane of the liquid crystal display. The uniform limitation on the applied voltage restricts the luminance of displayed images to the limited voltage range and may lower the brightness and the dynamic range of the displayed images.

### SUMMARY

There is a need of ensuring application of adequate voltages according to the tone values of image data to VA liquid crystal, thus enhancing the quality of images displayed on a VA liquid crystal display.

In order to satisfy at least part of the above and the other related demands, the present invention is directed to a control method of a liquid crystal display having multiple pixels for display of an image. The liquid crystal display includes liquid crystal molecules (VA liquid crystal) that are sealed between opposed base plates in each of the multiple pixels and are aligned in a vertical direction relative to the base plates in a non-voltage application state to block the transmission of light while changing their alignment toward a horizontal direction relative to the base plates with an increase in applied voltage to allow the transmission of light. The technique of the present invention takes advantage of the newly found transmittance-applied voltage characteristic, which differs by the position of a pixel on the screen plane of the VA liquid crystal. The control method of the liquid crystal display according to the invention does not uniformly restrict a tone-based voltage, which is to be applied to each of the multiple pixels on the liquid crystal display and corresponds to the tone value of image data at the pixel, but restricts the tone-based voltage of each pixel, based on the transmittance-voltage characteristic of the pixel that differs by the position of the pixel on the plane of the liquid crystal display.

The control method of the liquid crystal display according to the invention applies the tone-based voltage to each of the multiple pixels according to the transmittance-voltage characteristic of the pixel, which differs by the position of the pixel on the screen plane of the liquid crystal display. This arrangement effectively prevents a variation in luminance and ensures the required brightness and the required dynamic range over the whole screen plane of the liquid crystal display, thus further enhancing the quality of images displayed on the liquid crystal display.

In one aspect of the invention, the control method specifies an allowable voltage range of each pixel corresponding to an available transmittance range defined by a minimum transmittance and a maximum transmittance of the pixel, based on the transmittance-voltage characteristic of the pixel. When the tone-based voltage of each pixel is out of the allowable voltage range of the pixel, the control method restricts the tone-based voltage of the pixel to the allowable voltage range. This arrangement further enhances the effectiveness for preventing the variation in luminance and for ensuring the required brightness and the required dynamic range over the whole screen plane of the liquid crystal display. This has the greater contribution to the enhanced quality of displayed images.

The technique of the invention is also actualized by a control apparatus for a liquid crystal display having multiple pixels for display of an image. Here the liquid crystal display includes liquid crystal molecules that are sealed between opposed base plates in each of the multiple pixels and are aligned in a vertical direction relative to the base plates in a non-voltage application state to block the transmission of light while changing their alignment toward a horizontal direction relative to the base plates with an increase in applied voltage to allow the transmission of light. The control apparatus for the liquid crystal display includes: a storage module that stores a lower peak voltage and an upper peak voltage corresponding to a minimum transmittance and a maximum transmittance with regard to each of the multiple pixels, based on a transmittance-voltage characteristic of the pixel that differs by the position of the pixel on a plane of the liquid crystal display; and a limiting module that applies a tone-based voltage, which corresponds to a tone value of image data at each pixel, to the pixel for display of an image represented by the image data on the liquid crystal display. When the tone-based voltage of each pixel is out of an allowable voltage range defined by the lower peak voltage and the upper peak voltage of the pixel according to the transmittance-voltage characteristic of the pixel, the limiting module specifies the lower peak voltage and the upper peak voltage of the pixel as lower and upper limit voltages of the pixel and restricts the tone-based voltage of the pixel to the lower and upper limit voltages.

The control apparatus for the liquid crystal display according to the invention applies the tone-based voltage to each of the multiple pixels according to the transmittance-voltage characteristic of the pixel, which differs by the position of the pixel on the screen plane of the liquid crystal display. This arrangement effectively prevents a variation in luminance and ensures the required brightness and the required dynamic range over the whole screen plane of the liquid crystal display, thus further enhancing the quality of images displayed on the liquid crystal display.

In one aspect of the control apparatus for the liquid crystal display, the storage module stores the lower peak voltages and the upper peak voltages with regard to plural pixels sampled from the multiple pixels, based on transmittance-voltage characteristics of the sampled pixels. The limiting module determines lower and upper limit voltages of a specific pixel, which is different from any of the plural sampled pixels, by interpolation according to the transmittance-voltage characteristics of adjacent sampled pixels surrounding the specific pixel, which is different from any of the plural sampled pixels. When the tone-based voltage of the specific pixel is out of an allowable voltage range defined by the lower and upper limit voltages of the specific pixel determined by interpolation, the limiting module restricts the tone-based voltage of the specific pixel to the lower and upper limit voltages. This arrangement further enhances the effectiveness for preventing the variation in luminance and for ensuring the required brightness and the required dynamic range over the whole screen plane of the liquid crystal display. This has the greater contribution to the enhanced quality of displayed images.

### BRIEF DESCRIPTION OF THE DRAWINGS

FIG. 1 is a block diagram schematically illustrating the configuration of an image display apparatus using VA liquid crystal for image display in one embodiment of the invention.

FIGS. 2A and 2B show the newly found transmission-voltage characteristic of the VA liquid crystal under control of the image display apparatus.

FIG. 3 shows the storage contents in a peak voltage storage circuit included in the image display apparatus.

FIG. 4 shows control of the VA liquid crystal by the image display apparatus.

### DESCRIPTION OF THE PREFERRED EMBODIMENTS

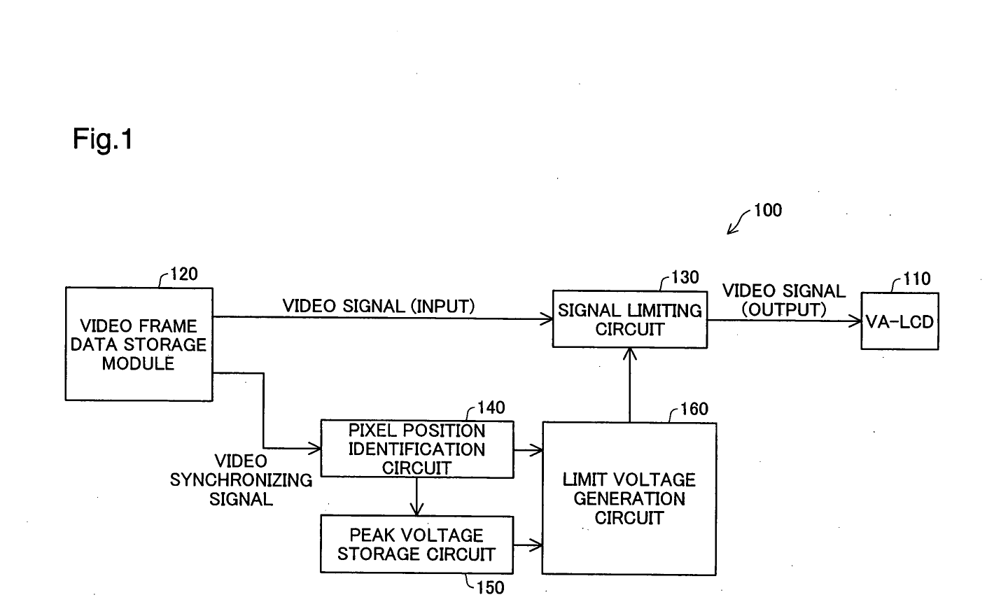

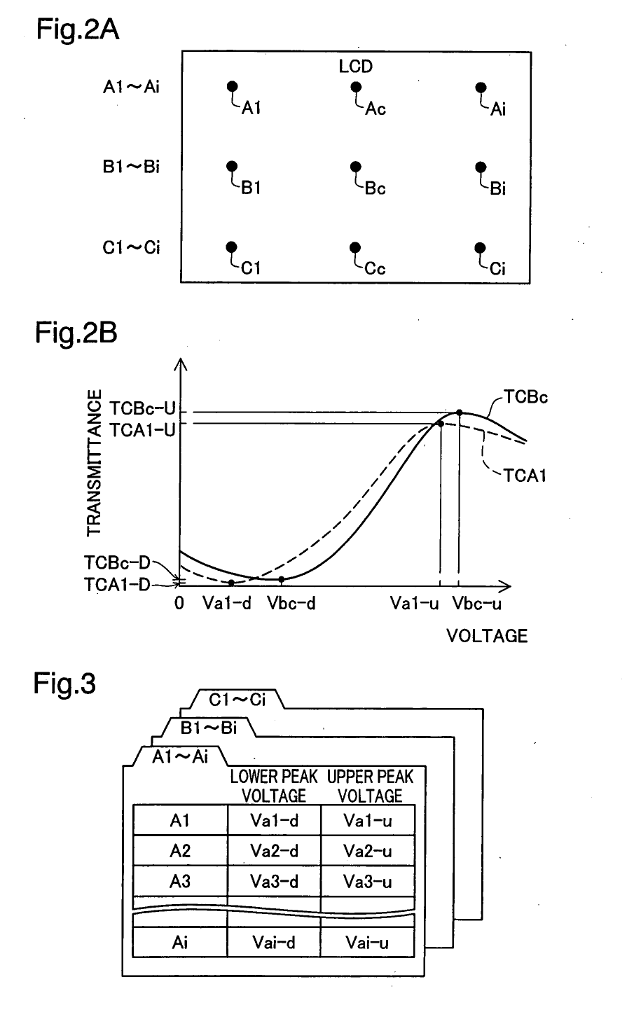

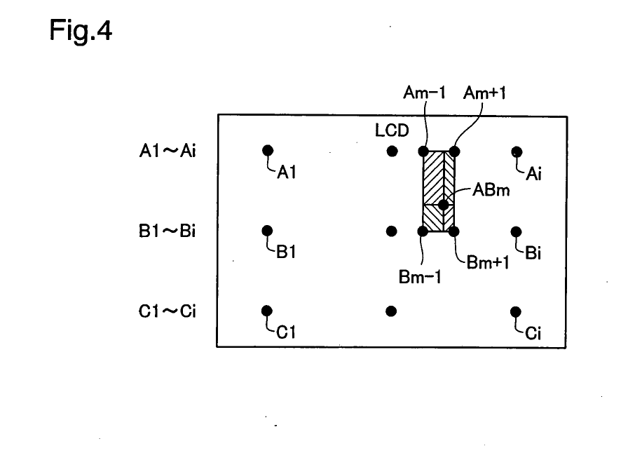

One mode of carrying out the invention is described below in detail as a preferred embodiment with reference to the accompanied drawings. FIG. 1 is a block diagram schematically illustrating the configuration of an image display apparatus 100 using VA liquid crystal for image display in one embodiment of the invention. FIGS. 2A and 2B show the newly found transmission-voltage characteristic of the VA liquid crystal under control of the image display apparatus 100. FIG. 3 shows the storage contents in a peak voltage storage circuit 150 included in the image display apparatus 100. FIG. 4 shows control of the VA liquid crystal by the image display apparatus 100.

As shown in FIG. 1, the image display apparatus 100 of this embodiment includes a VA liquid crystal display 110 (hereafter referred to as VA-LCD 110), a video frame data storage module 120, and a signal limiting circuit 130. The image display apparatus 100 displays images on the VA-LCD 110, based on video signals (frame data) stored in the video frame data storage module 120. Each video signal input into the signal limiting circuit 130 is processed by signal limiting (described later) and is output to the VA-LCD 110 for display of a corresponding image. In response to the input of the video signal into the VA-LCD 110, a scanning signal is output to each scanning line of pixels on the VA-LCD 110, and a voltage corresponding to the video signal is applied to each signal line of pixels.

The image display apparatus 100 also includes a pixel position identification circuit 140, a peak voltage storage circuit 150 for storage of lower and upper peak voltages corresponding to selected pixel positions, and a limit voltage generation circuit 160. A video synchronizing signal is input into the pixel position identification circuit 140, synchronously with input of the video signal from the video frame data storage module 120 into the signal limiting circuit 130. The pixel position identification circuit 140 identifies the position of each target pixel for display of an image corresponding to the input video signal (frame data), based on the video synchronizing signal. The identification of the pixel position determines the coordinates of the target pixel on the screen plane of the VA-LCD 110. The pixel position identification circuit 140 outputs the determined coordinates of the target pixel to the peak voltage storage circuit 150 and to the limit voltage generation circuit 160.

The peak voltage storage circuit 150 stores lower and upper peak voltages corresponding to multiple pixels sampled from the screen plane of the VA-LCD 110. The VA liquid crystal has a large number of pixels in a multiple-row, multiple-column arrangement on the screen plane. Each pixel has a different transmittance-applied voltage characteristic. The difference in transmittance-voltage characteristic according to the pixel position is described with reference to FIG. 2. In the illustrated example of FIG. 2A, pixels A1 through Ai, B1 through Bi, and C1 through Ci are sampled from three scanning lines located on the top, the center, and the bottom of the screen plane. The graph of FIG. 2B shows transmittance-voltage characteristic curves TCA1 and TCBc with regard to the upper left pixel A1 and the center pixel Bc on the screen plane.

As the common features of the characteristic curve TCA1 of the upper left pixel A1 and the characteristic curve TCBc of the center pixel Bc, the transmittance first decreases to a minimum or lower peak value with an increase in voltage from 0, then increases to a maximum or upper peak value with an increase in voltage from a lower peak voltage corresponding to the minimum transmittance, and again decreases with an increase in voltage from an upper peak voltage corresponding to the maximum transmittance. The characteristic curve TCA1 of the upper left pixel A1 and the characteristic curve TCBc of the center pixel Bc, however, have different minimum transmittances TCA1-D and TCBc-D and different maximum transmittances TCA1-U and TCBc-U, as well as different lower peak voltages Va1-d and Vbc-d and different upper peak voltages Va1-u and Vbc-u respectively corresponding to these minimum and maximum transmittances. In the case of application of the transmittance-voltage characteristic TCBc of the center pixel Bc to all the pixels on the screen plane of the VA-LCD 110, the upper left pixel A1 has a decreased transmittance or lowered luminance at the upper peak voltage Vbc-u of the center pixel Bc. Application of voltage around the upper peak voltage Val-u causes a variation in luminance.

In the image display apparatus 100 of this embodiment, with a view to preventing such a variation in luminance, the peak voltage storage circuit 150 stores lower peak voltages and upper peak voltages corresponding to minimum transmittances and maximum transmittances with regard to the respective sampled pixels A1 through Ai, B1 through Bi, and C1 through Ci (FIG. 2A) as shown in FIG. 3. The upper and lower peak voltages are measured for sampled pixels with regard to each production lot of VA-LCDs 110 or with regard to each individual VA-LCD 110.

The peak voltage storage circuit 150 retrieves its storage contents to extract a lower peak voltage and an upper peak voltage corresponding to the identified pixel position input from the pixel position identification circuit 140 and outputs the extracted lower peak voltage and upper peak voltage to the limit voltage generation circuit 160. When a pixel at the identified pixel position (coordinates) input from the pixel position identification circuit 140 matches with one of the sampled pixels stored in the peak voltage storage circuit 150, the peak voltage storage circuit 150 outputs the lower peak voltage and the upper peak voltage of the matched sampled pixel to the limit voltage generation circuit 160. When the pixel at the identified pixel position input from the pixel position identification circuit 140 does not match with any of the sampled pixels, on the other hand, the peak voltage storage circuit 150 outputs lower peak voltages and upper peak voltages of adjacent sampled pixels to the limit voltage generation circuit 160.

The output of the lower peak voltages and the upper peak voltages of adjacent sampled pixels is shown in FIG. 4. In the illustrated example of FIG. 4, a pixel ABm represents the identified pixel position input from the pixel position identification circuit 140. The peak voltage storage circuit 150 outputs lower peak voltages and upper peak voltages of adjacent sampled pixels Am−1, Am+1, Bm−1, and Bm+1 surrounding the pixel ABm to the limit voltage generation circuit 160.

The limit voltage generation circuit 160 generates lower and upper limit voltages of the pixel at the identified pixel position, based on the lower peak voltage and the upper peak voltage of the sampled pixel input from the peak voltage storage circuit 150 and the identified pixel position input from the pixel position identification circuit 140. When a control object pixel at the identified pixel position (coordinates) input from the pixel position identification circuit 140 matches with one of the sampled pixels stored in the peak voltage storage circuit 150, the limit voltage generation circuit 160 generates the lower peak voltage and the upper peak voltage input from the peak voltage storage circuit 150 as lower and upper limit voltages of the control object pixel and outputs the generated lower and upper limit voltages to the signal limiting circuit 130. When the control object pixel at the identified pixel position input from the pixel position identification circuit 140 does not match with any of the sampled pixels, on the other hand, the limit voltage generating circuit 160 generates lower and upper limit voltages of the control object pixel by interpolation with the lower peak voltages and the upper peak voltages of the four adjacent sampled pixels in the neighborhood of the control object pixel input from the peak voltage storage circuit 150 and outputs the generated lower and upper limit voltages to the signal limiting circuit 130. In the illustrated example of FIG. 4, the concrete procedure of interpolation divides a rectangle of the sampled pixels Am−1, Am+1, Bm−1, and Bm+1 into quarters at the crossing point of the control object pixel ABm, specifies the area fractions of the respective quarters as weighting coefficients, and multiplies the lower peak voltages and the upper peak voltages of the adjacent sampled pixels by the weighting coefficients.

The signal limiting circuit 130 restricts an applied voltage (tone-based voltage), which corresponds to the tone value of the video signal (frame data) at the control object pixel input from the video frame data storage module 120, by the lower and upper limit voltages of the control object pixel generated by and input from the limit voltage generation circuit 160. When the tone-based voltage is lower than the input lower limit voltage, the tone-based voltage is restricted to the lower limit voltage. When the tone-based voltage is higher than the input upper limit voltage, the tone-based voltage is restricted to the upper limit voltage. After such restriction, the tone-based voltage is applied to the signal line of the control object pixel on the VA-LCD 110.

As described above, the image display apparatus 100 of this embodiment uses the VA liquid crystal display (VA-LCD) 110 for display of images. The VA-LCD 110 has multiple pixels and includes liquid crystal molecules that are sealed between opposed base plates in each of the multiple pixels and are aligned in the vertical direction relative to the base plates in a non-voltage application state to block the transmission of light while changing their alignment toward the horizontal direction relative to the base plates with an increase in applied voltage to allow the transmission of light. By taking advantage of this characteristic of the VA liquid crystal, the voltage applied to each pixel is varied according to the position of the pixel on the screen plane. The peak voltage storage circuit 150 stores the lower peak voltages and the upper peak voltages corresponding to the minimum transmittances and the maximum transmittances (lower peak values and upper peak values of transmittance) with regard to the sampled pixels from the screen plane, based on the transmittance-voltage characteristic curves of the sampled pixels. The limit voltage generation circuit 160 generates lower and upper limit voltages of each object pixel, based on the stored lower peak voltages and upper peak voltages of the sampled pixels and the identified pixel position of the object pixel on the screen plane. The signal limiting circuit 130 restricts the tone-based voltage, which corresponds to the tone value of the video signal (frame data) at the object pixel and is to be applied to the object pixel, by the generated lower and upper limit voltages.

The image display apparatus 100 of the embodiment restricts the tone-based voltage, which is to be applied to each pixel on the screen plane of the VA-LCD 110, according to the transmittance-voltage characteristic of the pixel and applies the restricted tone-based voltage to the pixel. Such restriction effectively prevents a variation in luminance not only in the pixel but over the whole screen plane. The range of the tone-based voltage to be applied to each pixel is determined by the lower limit voltage and the upper limit voltage of the pixel according to the transmittance-voltage characteristic curve (see FIG. 2). The transmittance-voltage characteristic curve differs by the position of the pixel on the screen plane. This arrangement ensures the required brightness and the required dynamic range, thus enhancing the quality of images displayed on the VA-LCD 110.

With regard to each object pixel at the identified pixel position different from any of the sampled pixels having the lower peak voltages and the upper peak voltages stored in the peak voltage storage circuit 150, the limit voltage generation circuit 160 generates the lower and upper limit voltages of the object pixel by interpolation with the stored lower peak voltages and upper peak voltages of adjacent sampled pixels surrounding the object pixel. This arrangement more effectively prevents the variation in luminance and ensures the required brightness and the required dynamic range over the whole screen plane of the VA-LCD 110, thus further enhancing the quality of images displayed on the VA-LCD 110.

The embodiment discussed above is to be considered in all aspects as illustrative and not restrictive. There may be many modifications, changes, and alterations without departing from the scope or spirit of the main characteristics of the present invention. Any and all modifications within the meaning and range of equivalency of the claims are intended to be embraced therein. The scope and spirit of the present invention are indicated by the appended claims, rather than by the foregoing description.

What is claimed is:

1. A control method of a liquid crystal display having multiple pixels for display of an image,
the liquid crystal display including liquid crystal molecules that are sealed between opposed base plates in each of the multiple pixels and are aligned in a vertical direction relative to the base plates in a non-voltage application state to block the transmission of light while changing their alignment toward a horizontal direction relative to the base plates with an increase in applied voltage to allow the transmission of light,
the control method comprising:
applying a tone-based voltage, which corresponds to a tone value of image data at each pixel, to the pixel for display of an image represented by the image data on the liquid crystal display; and
restricting the tone-based voltage of each pixel, based on a transmittance-voltage characteristic of the pixel that differs by the position of the pixel on a plane of the liquid crystal display.

2. The control method of the liquid crystal display in accordance with claim 1, the control method further comprising:
specifying an allowable voltage range of each pixel corresponding to an available transmittance range defined by a minimum transmittance and a maximum transmittance of the pixel, based on the transmittance-voltage characteristic of the pixel; and
when the tone-based voltage of each pixel is out of the allowable voltage range of the pixel, restricting the tone-based voltage of the pixel to the allowable voltage range.

3. A control apparatus for a liquid crystal display having multiple pixels for display of an image,
the liquid crystal display including liquid crystal molecules that are sealed between opposed base plates in each of the multiple pixels and are aligned in a vertical direction relative to the base plates in a non-voltage application state to block the transmission of light while changing their alignment toward a horizontal direction relative to the base plates with an increase in applied voltage to allow the transmission of light,
the control apparatus comprising:
a storage module that stores a lower peak voltage and an upper peak voltage corresponding to a minimum transmittance and a maximum transmittance with regard to each of the multiple pixels, based on a transmittance-voltage characteristic of the pixel that differs by the position of the pixel on a plane of the liquid crystal display; and
a limiting module that applies a tone-based voltage, which corresponds to a tone value of image data at each pixel, to the pixel for display of an image represented by the image data on the liquid crystal display,
when the tone-based voltage of each pixel is out of an allowable voltage range defined by the lower peak voltage and the upper peak voltage of the pixel according to the transmittance-voltage characteristic of the pixel, the limiting module specifying the lower peak voltage and the upper peak voltage of the pixel as lower and upper limit voltages of the pixel and restricting the tone-based voltage of the pixel to the lower and upper limit voltages.

4. The control apparatus for the liquid crystal display in accordance with claim 3, wherein the storage module stores the lower peak voltages and the upper peak voltages with regard to plural pixels sampled from the multiple pixels, based on transmittance-voltage characteristics of the sampled pixels, the limiting module determines lower and upper limit voltages of a specific pixel, which is different from any of the plural sampled pixels, by interpolation according to the transmittance-voltage characteristics of adjacent sampled pixels surrounding the specific pixel, which is different from any of the plural sampled pixels, and
when the tone-based voltage of the specific pixel is out of an allowable voltage range defined by the lower and upper limit voltages of the specific pixel determined by interpolation, the limiting module restricts the tone-based voltage of the specific pixel to the lower and upper limit voltages.
